(19) United States
(12) Patent Application Publication
(10) Pub. No.: US 2024/0170766 A1
(43) Pub. Date: May 23, 2024

(54) BATTERY MODULE WITH VAPOR CHAMBER

(71) Applicant: HYUNDAI MOBIS CO., LTD., Seoul (KR)

(72) Inventor: Young Chan YOON, Anyang-si (KR)

(73) Assignee: HYUNDAI MOBIS CO., LTD., Seoul (KR)

(21) Appl. No.: 18/379,302

(22) Filed: Oct. 12, 2023

(30) Foreign Application Priority Data
Nov. 21, 2022 (KR) 10-2022-0156152

(51) Int. Cl. H01M 10/6569; H01M 10/613; H01M 10/653; H01M 50/209; H01M 50/519; H01M 50/569

(52) U.S. Cl. CPC H01M 10/6569; H01M 10/613; H01M 10/653; H01M 50/209; H01M 50/519; H01M 50/569

(57) ABSTRACT

Provided is a battery module with a vapor chamber in which a plurality of battery cells included in the battery module are cooled by the plurality of vapor chambers each filled with a working fluid.

### CROSS-REFERENCE TO RELATED APPLICATIONS

This application claims priority under 35 U.S.C. § 119 to Korean Patent Application No. 10-2022-0156152, filed on, Nov. 21, 2022, in the Korean Intellectual Property Office, the disclosure of which is incorporated herein by reference in its entirety.

### TECHNICAL FIELD

The following disclosure relates to a battery module with a vapor chamber, and more particularly, to a battery module with a vapor chamber in which a plurality of battery cells included in the battery module are cooled by the plurality of vapor chambers each filled with a working fluid.

### BACKGROUND

A battery used in a machine requiring output greater than output required for a conventional electric vehicle may generate a large amount of heat, and thus needs to be effectively cooled.

For example, air mobility may require two to three times or more greater output than the conventional electric vehicle. The air mobility requiring such greater output may generate a large amount of heat from its battery that is used as a power source, and the battery may thus need to be cooled more effectively.

FIG. 1 is a view showing a conventional cooling structure of a battery cell.

As shown in FIG. 1, a conventional cooling structure 2 of a battery cell may cool a battery cell 1000 by bringing a cooling block 2000 into contact with one side of the battery cell 1000.

In the conventional cooling structure 2 of the battery cell, a portion of the battery cell 1000 that is adjacent to the cooling block 2000 may be cooled to have a lower temperature. However, a portion of the battery cell 1000 that is far from the cooling block 2000 may be cooled to a higher temperature due to lower cooling efficiency.

In addition, the battery cell 1000 may have a temperature higher than an allowable temperature because the battery cell 1000 fails to be sufficiently cooled.

Therefore, when the battery cell is cooled using the conventional cooling structure 2 of the battery cell, a temperature deviation of the battery cell for each position may be large or the battery cell may be overheated to thus cause a problem such as lower performance of the battery cell. Therefore, it is necessary to develop a battery module having a cooling structure which may effectively cool the battery cell while minimizing the temperature deviation of the battery cell for each position.

### SUMMARY

An embodiment of the present disclosure is directed to providing a battery module having a cooling structure which may effectively cool a battery cell.

Another embodiment of the present disclosure is directed to providing a battery module having a cooling structure which may cool a battery cell while minimizing a temperature deviation of the battery cell for each position.

Aspects of the present disclosure are not limited to the above-mentioned aspects, and other aspects that are not mentioned here may be obviously understood by those skilled in the art from the following description.

In one general aspect, a battery module with a vapor chamber includes: a plurality of battery cells; a plurality of vapor chambers each installed between the adjacent battery cells among the plurality of battery cells, and absorbing heat occurring from the plurality of battery cells; a heat transfer interface material coupled to one side of the plurality of vapor chambers to be in contact with the plurality of vapor chambers and receiving heat from the vapor chambers; and a cooling channel coupled to one side of the heat transfer interface material to receive heat from the heat transfer interface material and transfer heat to the outside, wherein the vapor chamber has a chamber in which a fluid is able to circulate and move, the chamber is filled with a working fluid, and the working fluid is vaporized by receiving heat from the battery cell and circulates in the chamber while being liquefied by transferring heat to the heat transfer interface material.

The vapor chamber may include a condenser inserted into the heat transfer interface material, and at least a portion of the chamber may be included inside the condenser.

A length of the condenser may be 5% or more and 20% or less of a length of the vapor chamber in a length direction to be away from the heat transfer interface material.

The vapor chamber may be made of any one or more metals selected from copper, aluminum, steel, and titanium.

The working fluid may be made of any one or more of mineral oil, a fluorinated fluid, and an ester-based fluid.

A pad having elasticity may be installed between the vapor chamber and the battery cell adjacent to the vapor chamber.

The battery module may further include: a board installed on top of the plurality of battery cells, and including a bus bar electrically connecting the plurality of battery cells to each other and a printed wiring circuit board measuring the voltages and temperatures of the plurality of battery cells; a front plate coupled to the front of the plurality of battery cells; a rear plate coupled to the rear of the plurality of battery cells; a side plate coupled to a side of the plurality of battery cells; and an upper cover coupled to the top of the plurality of battery cells to cover the board.

The heat transfer interface material may have a thermal conductivity of 3 W/mk or more.

Details of other embodiments are included in the description and drawings of the present disclosure.

### BRIEF DESCRIPTION OF THE DRAWINGS

FIG. 1 is a view showing a conventional cooling structure of a battery cell.

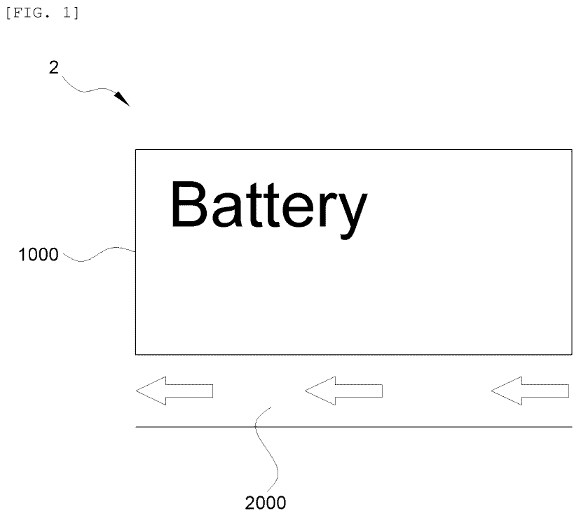

FIG. 2 is an exploded view showing a battery module with a vapor chamber according to an embodiment of the present disclosure.

FIG. 3 is a view showing the battery module with the vapor chamber in which a condenser of the vapor chamber is inserted into a heat transfer interface material.

FIG. 4 is a graph showing a thermal resistance based on a rate of a length of the condenser to a length of the vapor chamber.

FIGS. 5A to 5C are views showing each temperature of a battery cell based on a cooling method including a bottom cooling method, a cooling method including aluminum cooling fins, and a cooling method including the vapor chamber.

### DETAILED DESCRIPTION OF EMBODIMENTS

Hereinafter, embodiments are described in detail with reference to the accompanying drawings to be easily practiced by those skilled in the art to which the present disclosure pertains. However, the present disclosure may be implemented in various different forms and is not limited to the embodiments described herein. In addition, in the drawings, portions unrelated to the description are omitted to clearly describe the present disclosure, and similar portions are denoted by similar reference numerals throughout the specification.

Throughout the specification, when one part is referred to as being “connected to” another part, one part and another part may be “directly connected to” each other, or may be “electrically connected to” each other with a third part interposed therebetween.

Throughout the specification, when one member is referred to as being positioned “on” another member, one member and another member may be in contact with each other, or a third member may be interposed between one member and another member.

Throughout the specification, “including” one component is to be understood to imply the inclusion of other components rather than the exclusion of other components, unless explicitly described to the contrary. As used throughout the specification, a term of degree “about”, “substantially”, or the like is used to indicate the number of a stated meaning or its approximation when its manufacturing or material tolerance inherent therein are given. Such a term is used to prevent unscrupulous infringers from unfairly using the present disclosure in which exact or absolute figures are stated to facilitate the understanding of this application. As used throughout the specification, a term of “step of (doing)” or “step of˜” does not indicate a “step for˜”.

Hereinafter, embodiments of the present disclosure will be described in detail with reference to the accompanying drawings. However, the present disclosure is not limited to the embodiments described herein, and may also be embodied in another form. The same reference numerals denote the same components throughout the specification.

Hereinafter, the description describes a battery module with a vapor chamber according to an embodiment of the present disclosure.

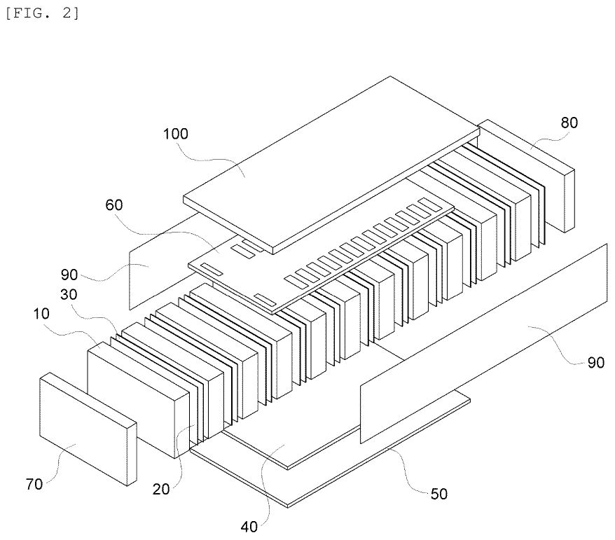

FIG. 2 is an exploded view showing a battery module with a vapor chamber according to an embodiment of the present disclosure.

Referring to FIG. 2, a battery module 1 with the vapor chamber may include a battery cell 10, a vapor chamber 20, a pad 30, a heat transfer interface material 40, a cooling channel 50, a board 60, a front plate 70, a rear plate 80, a side plate 90, and an upper cover 100.

First, the battery cell 10 is described.

The plurality of battery cells 10 may be provided, and the battery cell may be a conventional prismatic battery cell or a pouch-type battery cell.

Next, the vapor chamber 20 is described.

As shown in FIG. 2, the vapor chamber 20 may be installed between the adjacent battery cells 10 among the plurality of battery cells 10, and absorb heat occurring from the plurality of battery cells 10.

The vapor chamber 20 may be made of any one or more metals selected from copper, aluminum, steel, and titanium.

In addition, the vapor chamber 20 may have a chamber in which a fluid may circulate and move, and the chamber is filled with a working fluid. The working fluid may be vaporized by receiving heat from the battery cell 10, and circulate in the chamber while being liquefied by transferring heat to the heat transfer interface material 40 described below.

Here, the working fluid may be made of any one or more of mineral oil, a fluorinated fluid, and an ester-based fluid, having electrical insulation.

As such, the working fluid filling the vapor chamber 20 may be vaporized and liquefied while circulating in the chamber. Accordingly, heat emitted from the battery cell 10 may be dissipated to the outside through the heat transfer interface material 40 and the cooling channel 50 described below, thus cooling the battery cell 10.

Meanwhile, the vapor chamber 20 may include a condenser 22 inserted into the heat transfer interface material 40.

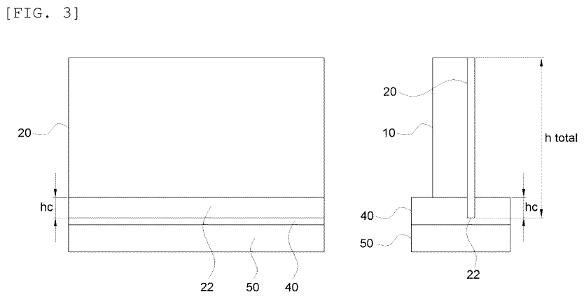

FIG. 3 is a view showing the battery module with the vapor chamber in which the condenser of the vapor chamber is inserted into the heat transfer interface material.

In detail, as shown in FIG. 3, the condenser 22 may be in contact with the heat transfer interface material 40 by being inserted into the heat transfer interface material 40.

Here, when the condenser 22 inserted into the heat transfer interface material 40 is made shorter, the working fluid filling the vapor chamber 20 may be completely vaporized without being liquefied, thus lowering a cooling function of the battery cell 10 of the vapor chamber 20.

On the other hand, when the condenser 22 inserted into the heat transfer interface material 40 is made longer, a volume of the battery module 1 with the vapor chamber may be excessively large.

Therefore, the condenser 22 needs to have a length enabling the battery module 1 with the vapor chamber to be prevented from being excessively large without lowering the cooling function of the battery cell 10.

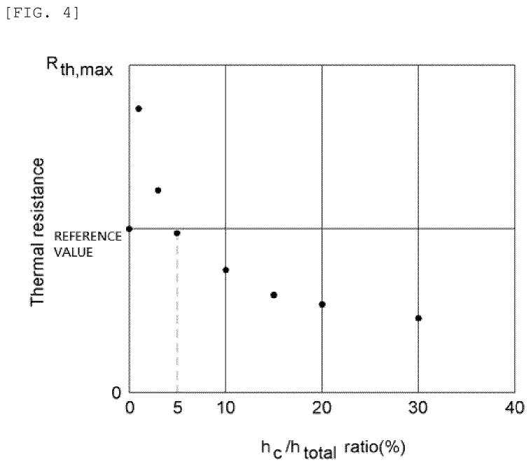

FIG. 4 is a graph showing a thermal resistance based on a rate of a length of the condenser to a length of the vapor chamber.

For example, as shown in FIG. 4, a length hc of the condenser 22 may be 5% or more of a length htotal of the vapor chamber 20 because the thermal resistance is a reference value or less when 5% or more is a rate of the length h1 of the condenser 22 to the length h2 of the vapor chamber 20 in a length direction to be away from the heat transfer interface material 40 (hereinafter, the length of the vapor chamber).

In addition, the length h1 of the condenser 22 may be 20% or less of the length h2 of the vapor chamber 20 because the volume of the battery module 1 with the vapor chamber is gradually increased while a degree of thermal resistance reduction is smaller although the thermal resistance is gradually reduced when the rate of the length h1 of the condenser 22 to the length h2 of the vapor chamber 20 is more than 20%.

Next, the pad 30 is described.

Referring to FIG. 2, the pad 30 may be installed between the vapor chamber 20 and the battery cell 10 adjacent to the vapor chamber 20, and have elasticity to suppress swelling of the battery cell 10 and swelling of the vapor chamber 20.

Next, the heat transfer interface material 40 may be described.

Referring to FIG. 2, the heat transfer interface material (TIM) 40 may be coupled to one side of the plurality of battery cells 10 to be in contact with the plurality of vapor chambers 20, receive heat from the plurality of vapor chambers 20, and transfer heat to the cooling channel 50 described below.

In addition, the heat transfer interface material 40 may have a thermal conductivity of 3 W/mk or more.

Next, the cooling plate 50 is described.

Referring to FIG. 2, the cooling channel 50 may be coupled to one side of the heat transfer interface material 40 to receive heat from the heat transfer interface material 40 and transfer heat to the outside.

This cooling channel 50 may be configured in the same way as a cooling block included in a conventional battery module.

Next, the board 60 is described.

Referring to FIG. 2, the board 60 may be installed on top of the plurality of battery cells 10, and include a bus bar electrically connecting the plurality of battery cells 10 to each other and a printed wiring circuit board (PCB) measuring the voltages and temperatures of the plurality of battery cells 10.

Next, the front plate 70, the rear plate 80, and the side plate 90 are described.

Referring to FIG. 2, the front plate 70 may be coupled to the front of the plurality of battery cells 10, the rear plate 80 may be coupled to the rear of the plurality of battery cells 10, and the side plate 90 may be coupled to the side of the plurality of battery cells 10.

The front plate 70, the rear plate 80, and the side plate 90 may each have a plate shape.

Next, the upper cover 100 is described.

Referring to FIG. 2, the upper cover 100 may be coupled to the top of the plurality of battery cells 10 to cover the board 60, and may have a plate shape.

The battery module 1 with the vapor chamber according to an embodiment of the present disclosure configured as described above may effectively prevent increase in the temperature of the battery cell 10, and may minimize a temperature deviation of the battery cell 10 for each position.

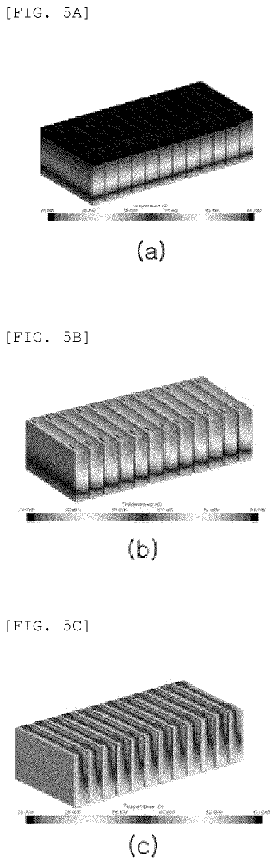

FIGS. 5A to 5C are views showing each temperature of the battery cell based on a cooling method including a bottom cooling method, a cooling method including aluminum cooling fins, and a cooling method including the vapor chamber.

In detail, the maximum temperature of the battery cell when using the bottom cooling method is about 60 degrees, and a temperature difference between the top and bottom of the battery cell is about 20 degrees (see FIG. 5A).

On the other hand, it may be seen that the maximum temperature of the battery cell when using the cooling method including the vapor chamber is about 42 degrees, the temperature difference between the top and bottom of the battery cell is about 8 degrees or less (see FIG. 5C), and the battery is thus cooled more effectively when the battery cell is cooled using the cooling method including the vapor chamber than when the battery cell is cooled using the bottom cooling method, and has the minimized temperature deviation for each position.

Similarly, it may be seen that the battery is cooled more effectively when the battery cell is cooled using the cooling method including the vapor chamber than when the battery cell is cooled using the cooling method including the aluminum cooling fins, and has the minimized temperature deviation for each position (see FIG. 5B).

As set forth above, the battery module with the vapor chamber according to the present disclosure may cool the battery cell by using the vapor chamber filled with the working fluid to have high thermal conductivity, thereby effectively cooling the battery cell.

In addition, the battery module with the vapor chamber according to the present disclosure may cool the battery cell by using the vapor chamber with the high thermal conductivity. Therefore, heat emitted from the battery cell may be effectively diffused to minimize the temperature deviation of the battery cell for each position, which may prevent lower performance of the battery cell.

The above-described embodiments are illustratively provided, and it is apparent to those skilled in the art to which the present disclosure pertains that the present disclosure may be embodied in another specific form without any change in the technical idea or essential characteristics of the present disclosure. Therefore, it is to be understood that the embodiments described above are illustrative rather than being restrictive in all aspects. For example, the components each described as a single type may also be implemented in a distributed manner, and similarly, the components described as being distributed from each other may also be implemented in a combined manner.

It is to be understood that the scope of the present disclosure is defined by the claims disclosed below rather than the detailed description provided above, and includes all alternations and modifications derived from the claims and their equivalents.

What is claimed is:

1. A battery module with a vapor chamber, the battery module comprising:
a plurality of battery cells;
a plurality of vapor chambers each installed between adjacent battery cells among the plurality of battery cells, and configured to absorb heat generated from the plurality of battery cells;
a heat transfer interface material coupled to one side of the plurality of vapor chambers, in contact with the plurality of vapor chambers and configured to receive heat from the vapor chambers; and
a cooling channel coupled to one side of the heat transfer interface material configured to receive heat from the heat transfer interface material and transfer heat to an outside of the battery module,
wherein the vapor chamber has a chamber in which a fluid is able to circulate and move, the chamber is filled with a working fluid, and the working fluid is vaporized by receiving heat from the battery cell that circulates in the chamber while being liquefied by transferring heat to the heat transfer interface material.

2. The battery module of claim 1, wherein the vapor chamber includes a condenser inserted into the heat transfer interface material, and
wherein at least a portion of the chamber is included inside the condenser.

3. The battery module of claim 2, wherein a length of the condenser is 5% or more and 20% or less of a length of the vapor chamber in a length direction.

4. The battery module of claim 3, wherein the vapor chamber is made of any one or more metals selected from copper, aluminum, steel, and titanium.

5. The battery module of claim 4, wherein the working fluid is made of any one or more of mineral oil, a fluorinated fluid, and an ester-based fluid.

6. The battery module of claim 5, wherein a pad having elasticity is installed between the vapor chamber and the battery cell adjacent to the vapor chamber.

7. The battery module of claim 6 further comprising:
a board installed on top of the plurality of battery cells, including a bus bar electrically connecting the plurality of battery cells to each other and a printed wiring circuit board measuring voltages and temperatures of the plurality of battery cells;
a front plate coupled to the front of the plurality of battery cells;
a rear plate coupled to the rear of the plurality of battery cells;
a side plate coupled to a side of the plurality of battery cells; and
an upper cover coupled to the top of the plurality of battery cells to cover the board.

8. The battery module of claim 7, wherein the heat transfer interface material has a thermal conductivity of 3 W/mk or more.
